(19) United States
(12) Patent Application Publication
(10) Pub. No.: US 2002/0198612 A1
(43) Pub. Date: Dec. 26, 2002

(54) Apparatus and method tracking competitor movement in a sporting event

(76) Inventors: John Justin Smith, Bedford (GB); Martin Peters, Lang Lang (AU)

Correspondence Address: Gerald T. Shekleton, Esq., Welsh & Katz, Ltd., 22nd Floor, 120 S. Riverside Plaza, Chicago, IL, 60606, US

(21) Appl. No.: 10/135,468

(22) Filed: Apr. 30, 2002

(30) Foreign Application Priority Data
Jun. 25, 2001 (GB) 0115485.5

(51) Int. Cl. G06F 155/00

(52) U.S. Cl. 700/91

(57) ABSTRACT

A method of monitoring a plurality of competitors in a sporting event, comprises having each of said plurality of competitors carry a respective position locating device, arranging for the position locating devices to make location determinations at intervals and provide such determinations as output positional location data for the respective competitors of said plurality of competitors and collecting output data for the plurality of competitors.

The present invention relates to monitoring a plurality of competitors in a sporting event. In particular it relates to methods and apparatus for determining the positions and/or speeds of competitors.

Currently there is an ever growing public desire for more detailed analytical and/or pictorially represented information regarding sporting events.

In horse racing, for example, it has been desired to have information about a horses speed around the track or course. Until now, the speed of a horse as it moves around a racetrack has been calculated by sectional timing over substantial track lengths. Sectional timing involves the calculation of average speed by recording the distance between two fixed points, and the time taken to cover that distance. Because of the length of sections over which timing has taken place this type of timing system may be misleading. Consider the last five furlongs of a race, where three horses achieve not dissimilar sectional times. The timed measure of performance would thus appear to be substantially equal for these animals. However, in actual fact, the first horse might maintain the same speed throughout the entire five furlongs, the second horse start faster but slow down at the end, and the third horse start slower but finish faster. Under such sectional timing, as mentioned, the performance rating of each horse would appear to be equal, whereas it would be appropriate that the third horse receive the best rating, as a result of his greater stamina, while the first horse should be rated second, and the second horse third.

According to one aspect of the present invention, a method of monitoring a plurality of competitors in a sporting event is provided, the method comprising the steps of:

a. having each of said plurality of competitors carry a respective position locating device;

b. arranging for the position locating devices to make location determinations at intervals and provide such determinations as output positional location data for the respective competitors of said plurality of competitors; and

c. collecting output data for the plurality of competitors.

According to another aspect of the present invention, an apparatus for monitoring a plurality of competitors in a sporting event is provided, the apparatus comprising:

a. a position locating device to be carried by each of said plurality of competitors;

b. means for causing the position locating devices to make location determinations at intervals and to provide such determinations as output positional location data for the respective competitors; and

c. means for collecting output data for the plurality of competitors.

According to a further aspect of the present invention, an apparatus for monitoring a competitor in a sporting event is provided, the apparatus comprising:

a. a position locating device to be carried by the competitor, the device being adapted to make location determinations at intervals and to provide such determinations as output positional location data for the competitor; and

b. means for use in collecting said output data.

Solely by way of example, an embodiment of the invention will now be described, with reference to the following drawings in which:

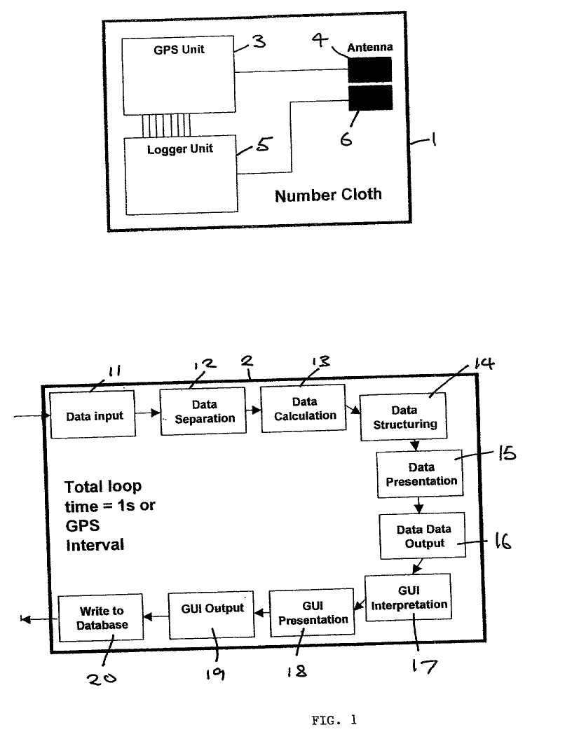

FIG. 1 is a block diagrammatic representation of apparatus for use in obtaining and recording/displaying positional data and data derived therefrom with respect to racehorses on a racecourse;

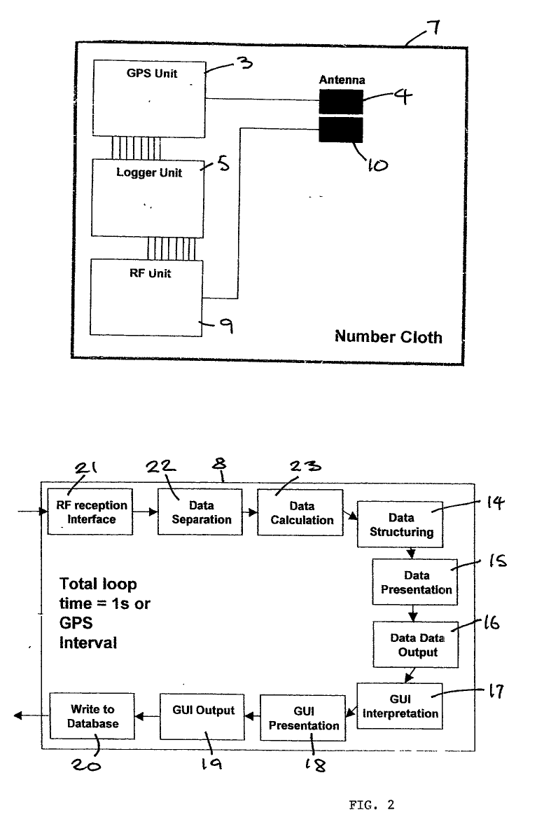

FIG. 2 is a block diagrammatic representation of alternative apparatus for use in obtaining and recording/displaying positional data and data derived therefrom with respect to racehorses on a racecourse;

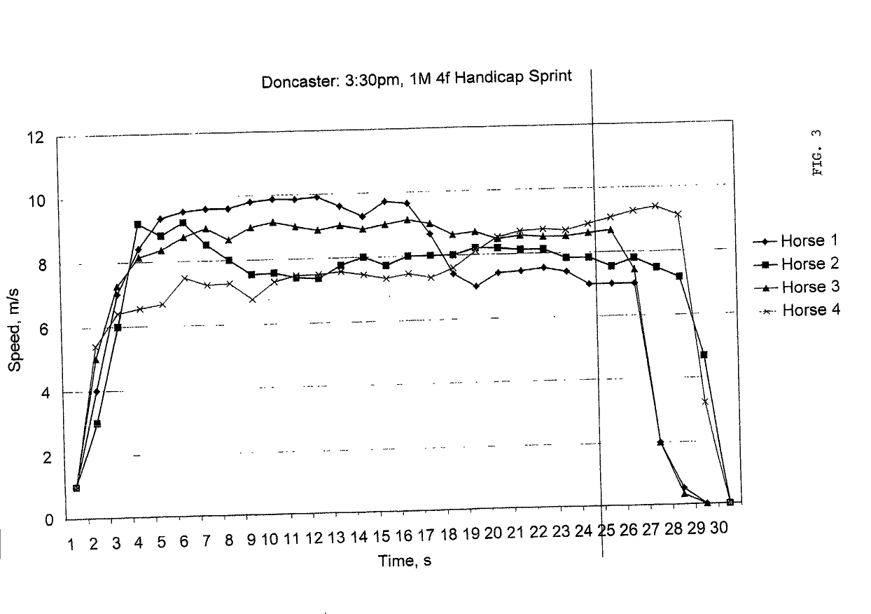

FIG. 3 is a graphical representation of data derived using the apparatus of FIG. 1 or FIG. 2; and

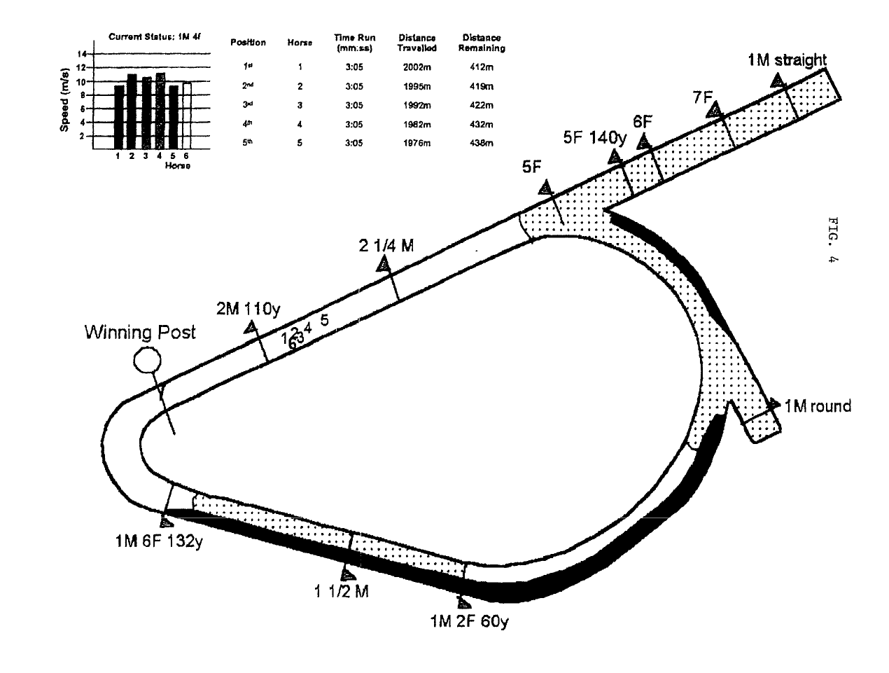

FIG. 4 is a graphical display displaying data obtained with the apparatus of FIG. 1 or FIG. 2.

A particularly advantageous application of the present invention is in the obtaining, presentation and display of competing horses in a horseracing event. The drawings show apparatus used in a method of acquiring data for presentation of the position and velocity of a plurality of horses involved in a horserace, for the recording of this information for the duration of a race, for subsequent comparison between animals and for post race analysis and examples of possible displays for the data. While position and speed information may, in accordance with the invention, be processed and presented on a display substantially in real time, the method may also rely on storing the information for use in post event processing and presentation, depending on what is preferred and, possibly, on on-site resources and economics.

In the preferred embodiment of the invention those horses in a horserace for which speed and/or positional location data is desired are monitored by having each of these horses carry a position locating device which performs location determinations at closely spaced time intervals. Clearly the position locating devices should be as small as is reasonably possible so as not to increase the weight carried by the horses or to be too obtrusive in any way. The data produced by these devices is then used to determine and display the speed and/or position of these horses, the speed being the speed of travel between location measurements and the positions corresponding to the location measurements.

A particularly suitable position locating device to use is a global positioning satellite (GPS) receiver—a digital device capable of decoding satellite information in order to accurately determining its position on the globe. A GPS receiver needs to receive three satellite signals for a basic “fix” to be achieved. This fix pinpoints latitude and longitude, and is achieved through triangulation. To ascertain position in a third dimension, eg. height or altitude, a fourth satellite is needed.

Accuracy of determination of position through the satellites increases with the number of acquired satellites the GPS receiver is receiving signals from. Similarly, extraneous satellites on the horizon, below a specific “Mask Angle” can introduce error due to their distance from the receiver. In these circumstances, it is preferable that these extraneous satellites be ignored in order to concentrate on those within a specific angle above the position of the receiver on the surface of the globe.

Since the satellites used now by everyone taking advantage of the GPS system are owned by the US military and were intended for military purposes, the US military introduced an error into the system called “selective availability” so that the general public or foreign entities could not obtain such accurate positional information as was available to the US forces, who could simply eliminate or nullify the error. This selective availability reduced the accuracy with which a normal GPS receiver can determine position, typically to about +/−50 m. Consequently, a set of correction utilities was formed. These can be beacon transmitters. These beacons know exactly where they are on the globe, and receive information from orbiting satellites telling them where they think they are, allowing them to calculate the error caused by selective availability and other errors such as ionospheric and tropospheric errors, and to transmit this information to other GPS receivers. This improves GPS accuracy, and provides sub meter accuracy. The generic term for a GPS receiver that makes use of this system is a differential global positioning satellite (DGPS) receiver. An inverse differential system may also be used. Inverse differential is the use of a base station, measuring error, and the error is corrected after the data has been sent to the processor. Essentially, there are two datasets, and one is subtracted from the other to achieve a more accurate position. One measures the extent and direction of error from a known point; the other measures the position of the target object.

Similarly, other correction methods have been made available, all based on the same principal, such as EGNOS/WAAS (wide area augmentation system—developed by the US FAA) or Omnistar from OmniStar BV, PO Box 113, 2260 AC Leidschendam, The Netherlands. An alternative to the DGPS style receivers are those which use the RTK (real time kinematics) system. This type of system combines satellite acquisition and correction systems, and provides its own correction system close to the source of use of the GPS. Additionally, due to the increased proximity of the measuring GPS receiver and the correction transmitting GPS receiver, errors caused by ionospheric conditions can be substantially eliminated. The general accuracy of RTK GPS receivers can be sub cm.

Any type of small accurate GPS receiver may be used in the present method. However, clearly, the use of the more accurate DGPS or RTK GPS systems may be preferable. The Oncore M12 receiver marketed by Motorola GPS products, c/o BFI Optilas GmBH, Lilienthalstr, 14, D-85391, Neufahm, Germany (www.oncore.motorola.com) is a suitable low cost receiver for the speed sensing of horses.

Data Output from a GPS receiver can generally be in one of two forms, that of raw data output, generally interrogated through DOS (Disk Operating System) commands using normal PC equipment, or according to the NMEA0183 standard (National Marine Electronics Association PO Box 3435, New Bern, N.C. 28564-3435, http:/www.nmea.org/0183.htm.). This standard defines the electrical signal requirements, data transmission protocol, timing and specific sentence formats for serial data bus systems. NMEA0183 is a marine based format used to co-ordinate vessels in maritime scenarios which can be used in the present method of monitoring horse speed and/or location. Previously, as noted above, horse speed was calculated by ascertaining the time taken to cover a known distance. However, one can instead calculate speed by ascertaining the distance covered in a known time interval. It is usual for a GPS unit to output data at least once a second. Consequently the speed of a horse can be derived by having the horse carry a GPS receiver, which outputs location data at regular intervals, and calculating the distance covered in the intervals from the consecutive location data outputs. There are numerous formats of NMEA0183 output, one of which includes a calculated speed (measured in Knots, which can, clearly, rapidly be converted to other formats, eg. mph).

Location data output from a GPS receiver, in addition to being pulsed at one output every second, may also be streamed (i.e. constantly updated in real time) at five outputs per second, as is common with the RTK or Carrier Phase systems. Subsequent development may produce higher rates of “streaming”.

FIG. 1, illustrates a system for collecting data for a horse during a race and for processing that data subsequent to the race. The equipment is formed of two parts, one part 1,which is carried by the horse, and a second part 2, which is separate from the horse and stationed conveniently with relation to the track. Part 1 comprises a position locating device in the form of a GPS unit 3 which is coupled to receive satellite input signals from a GPS antenna 4. A data retrieval and logger unit 5 for is connected to the GPS unit 3 to obtain the positional data output of the GPS unit. The logger unit 5 is also connected to a data transmission system 6, preferably an infra red (IR) system. The transmission system 6 is an input/output system permitting data to be output for use in part 2 and also permitting the receipt of information which may be utilised via the logger unit 5 for initialising or otherwise controlling the GPS unit 3. GPS information from GPS unit 3 is interrogated by a miniature data retrieval and logging unit 5. This unit 5 is small, typically the same size as the GPS unit, eg. 40 mm×60 mm×10 mm, and is mounted in piggy-back style to the direct transmission output of the GPS unit. The data retrieval and logging unit preferably comprises a micro-controller, a personal computer (PC) interface, a power supply, and either non-volatile storage, battery backed SRAM and/or flash memory.

The micro controller preferably uses a dual UART (universal asynchronous receiver-transmitter) system for interfacing between the GPS receiver and the transmission system or PC (depending on whether real time or post race retrieval is being used). One UART is required to interface between the GPS unit 3 and the logger 5, and another between the logger and data transmission system 6, be it IR or direct PC link. The processor preferably has low current consumption and a fast power down mode for reduced power consumption between data pulses. The non-volatile data storage preferably comprises a Serial EEPROM, typically which will store 32 Kb of data. Multiples can be used in tandem as required. For post race processing an RS 232 serial interface or an IR interface 6 may be used for data offload, and processor programming. The batteries used may be standard discharge or rechargeable depending upon the equipment used. FIG. 2 also shows a system for collecting data for a horse in a race but in this case it is intended that the information will be used for real time display of information during the race. Components which are the same as or which correspond to those of FIG. 1 have been given the same reference numbers. As with the system of FIG. 1, the system is formed of two parts, parts 7 and 8. Part 7 is the part carried by the horse and part 8 is the stationary part located at a suitable place for obtaining and processing information from part 7. Part 7 comprises a GPS unit 3 data retrieval and logger unit 5 and antenna 4 connected to each other as in part 1 of FIG. 1. The logger unit is additionally connected to an RF unit 9 which in turn is connected to an RF antenna 10. Logger unit 5 can receive and transmit data via the RF unit 9 and antenna 10. Since, in this case, speed and/or location data are to be relayed substantially in real time, the primary purpose of the logger unit 5 is to interface the GPS unit with any subsequent transmission system, such as radio frequency transmission unit 9, but it may also be used to provide a fail-safe data storage facility for post race offload or downloading. The transmission system for real time transmission is preferably a radio frequency transmission unit 9, miniaturised to reduce weight and power consumption. This in turn may be mounted in piggy-back style on the data retrieval and logging system, or positioned in the close vicinity thereof. The purpose of the transmission equipment is to transmit the GPS location data from unit 7 to a receiving station 8 located nearby for subsequent data processing and presentation.

The GPS receiver and associated equipment of parts 1 and 7, of FIGS. 1 and 2, are preferably, for ordinary horse racing, provided in the number cloth of the horse which each horse has at race time. Each horse is issued with a number cloth relevant to its number in the race. The GPS unit 3, logger unit 5 and, in part 7, the RF unit 9 are enclosed within a potted plastic, lightweight enclosure. The size of the apparatus means that the devices will not be obtrusive, despite being encased such that damage from body moisture, environmental conditions, impact or potential interference is minimised. The equipment also comprises at least one aerial 4 to receive the GPS signal, with a second aerial 10 being required where data is being transmitted back to a nearby receiving station. The aerials used should be of low weight with a minimal noise threshold, and stitched into the seam of the number cloth so as to provide substantially annular shaped aerials to obtain the maximum amount of coverage for the size of the number cloth.

Whilst number cloths are convenient to use for normal horse racing the units 1 and 7 can be provided in other forms. They could be carried by the jockeys' helmets or on other parts of the horse. This would be necessary for example for point-to-point racing where number cloths are not used. Whatever system is used, the weight and size of the units should be kept as small as possible.

Data acquisition is started after the invocation of the GPS 3 and logger unit 5. This is preferably achieved by sending an infra-red (IR) signal from a palm-top computer. Preferably the IR signal also programs each individual GPS unit 3 from said palm-top, and assigns a unique identification (ID) to the unit. This will normally, but not necessarily, correspond to the number of the number cloth and hence the horse in the race.

Upon starting of the GPS receiver, initialisation strings are sent to the GPS unit by the logging and processing board informing it of the parameters associated with the particular racetrack. This information includes the information to start the acquisition of satellites, the loading of an almanac of stored fix positions, and the satellites to include in the tracking operation. Additionally, the mask angle of reception may be defined.

GPS receiver output continues through the race. A trigger system on a separate GPS unit located near the processing PC is used to establish the exact atomic time of the start of the race. This information is required to filter extraneous pre-race data, in particular where data is stored for post-race processing and display. Preferably location data has already been acquired for the racecourse, for instance by using the method and apparatus disclosed in patent application GB0106531.7, by the same applicant and the disclosure of which is incorporated herein by reference, such that exact geographical location of the finishing post is known, allowing extraneous post-race data also to be filtered. In situations where post-race processing and display is being carried out, the extraneous data referred to above may be filtered out by either manual or automated processing. In real time applications, extraneous data is filtered out automatically.

Data acquisition is preferably ceased as the horses exit the course after the race and is also achieved by IR signalling, eg. at the same time at which data is, if necessary, offloaded from the logging unit. Preferably this data offload is also achieved by IR signalling, and takes place at high baud rates (such as 9600-19200 bps) to reduce time of offload. All data is transferred to a data processing means which preferably comprises a base personal computer (base PC). If RF transmission has been used then data offload from the logger unit is, of course, not necessary as the GPS receiver output data will already have been recorded direct to the base PC. However, if data has also been stored on the logger unit as a backup, IR offload may also take place at this stage. Invocation of the GPS units is still required. With the real time system of FIG. 2, it may be convenient to have an infra red unit connected to the logger unit and to have the necessary interface unit 6 for the invocation processes etc. referred to above. However, some or all of the procedures may be carried out using RF signals instead.

On reception of output data from a horse, be it post race from the storage device, or real time from RF transmission, the collected data is processed by data processing means. Depending on the particular GPS receiver data output, the required processing will differ. Additionally, substantially real time presentation of information will require substantially real time processing, while displaying the position of the horses on the racetrack will require graphical output, which is particularly desirable for media applications.

Data processing of the data logged by the logger unit 5 of FIG. 1, is carried out by the units shown in the processor part, part 2 of the figure, to allow post race analysis of the data. The processor will have the facility to play back the race, in a scaled time design, i.e. replaying each seconds worth of data after the race. Similarly, the processor is also capable of assimilating the data and producing the necessary charts that may be desired.

The data is inputted into the processor part 2 through input unit 11, and separated in separation unit 12 into constituent packets depending on the horse and the atomic time of data recording, whereby the different files can be substantially instantaneously synchronised. Subsequently, calculations can be made in unit 13 to calculate, for a given atomic time and horse number, the speed of the horse, and the distance travelled between the two points sequentially of each other.

The data is then structured by structuring unit 14 and converted in subsequent units presentation unit 15, data output unit 16, GUI interpretation unit 17, GUI presentation unit 18 and GUI output unit 19—to provide for the particular form of data output that is desired. This again may be in many different formats. A typical format is shown in FIG. 3, which will be discussed below.

The data may be required to output to media for television representation. As such, the graphical user interface (GUI) needs to be interpreted in unit 17 and converted to a suitable output for media broadcast.

Finally, the data is written by unit 20 to a database where all horse information is stored. In the post processing operation, this procedure described, may be an effectively instantaneous operation, or a playback over time.

FIG. 2, represents the apparatus for the real time system with radio transmission. Essentially, unit 7 is similar in construction to the unit 1 of FIG. 1, with the main difference being the integration of a miniature radio frequency transmitter 9, of low power requirement mounted in “piggy-back” formation onto the back of the GPS board 3, and logger unit 5. Whilst, as shown, the system comprises the three components 3, 5 and 9 it is likely that the two units 3 and 9 would suffice, with logging requirements being satisfied at the processor end 8 of the link. This in turn would negate the need for any subsequent data offload by IR.

Essentially, GPS unit 3 derives its position, and transmits this via RF unit 9 and antenna 10 to an RF reception interface 21, of the processor unit part 8, which has the capability to receive multiple data inputs. The information from all runners is relayed in this way to interface 21 of the processor 8, which then runs through a number of procedures. The data is separated in unit 22 into groups depending on the horse's unit which sent the data. This allows the calculation, by calculation unit 23, of the distance travelled since the last reception. At this point, redundancy in terms of lost data is accounted for. The atomic time should be one second ahead for each data transmitted. If it is not, then data has been lost, and speed accuracy may be lost. Speed is calculated from the grouped data, and a speed output can be produced. The data from each unit is then structured to allow multiple output of runners. This process therefore implies, data separation, calculation and regrouping. The data can then be presented in any fashion appropriate using the units 14 to 19 corresponding to the units with the same references in FIG. 1. As stated earlier, there are numerous ways of presenting the data and the graphical data can be output to Broadcast Media. Finally, the data is written to a database for storage as with the system of FIG. 1. This entire processing loop takes of the order of one second to cope with the regular batches of data arriving at one second intervals.

In particular, the data processing means may carry out one or more of the following steps:

a) calculating the horses geographical position within the racing boundary;

b) calculating the positions of the other animals in relation to each other;

c) calculating the distance moved in the interval between GPS receiver outputs from said outputs;

d) calculating the speed of the horses from the distance calculated in (c) and the time between outputs; and

e) displaying of speed in bar chart or any other charting format.

f) displaying the speed and or positional information in any other suitable form of display.

Steps (b) and (c) in particular may not be required if already calculated by the GPS receiver (provided the GPS output is in the desired unit system) and transmitted to the receiving station. Calculations are preferably carried out as the necessary data reaches the receiving station.

The processed data is as mentioned stored in a database. The database may also be used as a facility to house other horse or racetrack information, such as the going and weather conditions on the race day, and the horses' weights. The data processing means can in turn access all information in the database, allowing the speed data produced in the race to be displayed in a number of formats. Where the database is accessible over the internet means may be provided for allowing the internet user to select what parameters are displayed.

Speed data may be presented in a number of different formats. For example:

a) One horse's speed v another horse's speed around the course;

b) One horse's speed v the course going conditions;

c) One horse's speed v weather;

d) One horse's speed v previous performances;

e) All horses speed v going conditions;

f) All horses v weather conditions; and

g) All horses v going and weather conditions.

A graphic equaliser type display may be used with an x-axis division for each contender, and a y-axis scale for speed.

FIG. 3 shows one form in which the processed speed data information may be presented This figure, which is purely diagrammatic graphical representation, demonstrates the representation of speed over time for four horses in a race represented as having been run at Doncaster at 3.30 pm. The elapsed time is shown in seconds on the x-axis and the instantaneous speed is shown in meters/second on the y-axis. The graphs show a gradual increase in speed for each horse over the first few seconds after the start, and of particular note is the drop off in speed of horse 1 after 20 or so seconds. The finishing line crossing time for each horse could be added to the chart for completeness.

FIG. 4 shows diagrammatically a GUI screen representation, suitable for broadcast media presentation, of Doncaster racecourse during a race. This is simply one form of real time display that could be produced using the system and method of the invention shown in FIG. 2. As shown there are 5 runners displayed, each represented by a different symbol although in practice media representations would normally be in colour with each horse being represented by a different colour. The horses are shown racing down the home straight in a race of 1M 4f. There are various aspect of this display that are significant.

The going, as determined for example according to our co-pending application GB01 10686.3, can be superimposed behind the racing horses, thus indicating areas where we can expect speed to increase or decrease. A graphic equaliser type display of each horses speed is presented and updated every second in the top left hand corner of the screen, and a table is also presented to textually represent the speed in race time. This figure is representative of the RF real time system of FIG. 2 where information is processed in race time and presented in media format.

The course can be any at which racing is taking place and there can be as many horses displayed as is possible within a race. For example, the Grand National commonly has about forty entries. This figure gives an example of the type of data that can be derived from the speed sensing system. Obviously, a number of different parameters can be presented:

Max Speed

Best Position

Average Speed

Distance travelled

Distance to run

Distance between horses

Expected race time for finish

Expected winner at sectional points

Average speed over specific going areas Etc.

Presentation formats may include TV broadcast, WAP, HTML/Internet, email, paper hard copy, or any other available method of presentation.

Whilst the invention has been applied, as described, to horses and horseracing it clearly can also be used for other sporting events, such as motor racing, rallying, team competitive sports, running etc.

Also, the description has concentrated on the presently favoured form of position locating device, a GPS unit. Other forms could be envisaged. For example the position locating device could be a transmitting sensor of the kind used in car theft tracking arrangements and various triangulation locating systems could be used.

1. A method of monitoring a plurality of competitors in a sporting event, the method comprising the steps of:
a. having each of said plurality of competitors carry a respective position locating device;
b. arranging for the position locating devices to make location determinations at intervals and provide such determinations as output positional location data for the respective competitors of said plurality of competitors; and
c. collecting output data for the plurality of competitors.

2. A method according to claim 1, wherein said collected data comprises said positional location data.

3. A method according to claim 1, wherein the collected data comprises said positional location data and wherein the collected positional location data and the length of time of said intervals between location determinations are processed to determine the speeds of said plurality of competitors.

4. A method according to claim 1, wherein each of said plurality of competitors carries means for determining their own speed from their own output positional location data and the length of time of said intervals between location determinations, said collected data comprising output speed data produced by said speed determining means.

5. A method according to claim 1, wherein each of said plurality of competitors carries means for determining their own speed from their own output positional location data and the length of time of said intervals between location determinations, said collected data comprising said output positional location data and output speed data produced by said speed determining means.

6. A method according to any of claims 1 to 5, wherein said collected data is processed to provide tracking information to obtain a display of the relative positions of said plurality of competitors.

7. A method according to any of claims 1 to 5, wherein the sporting event takes place on a sporting ground and said collected data is processed in combination with location data for the sporting ground to obtain a display of the positions of the competitors on the sporting ground.

8. A method according to any of claims 1 to 5, wherein the collected data is processed to display the speeds of said plurality of competitors relative to each other.

9. A method according to any of claims 1 to 5, wherein the sporting event takes place on a sporting ground and the speed of each competitor is indexed relative to its position on the sporting ground, location data for the sporting ground having previously been acquired.

10. A method according to claim 1, wherein the position locating devices comprise respective GPS receivers.

11. A method according to claim 1 or 10, wherein said intervals between location determinations are each 1 second or less.

12. A method according to claim 1, wherein collection of said output data is effected by providing each competitor with a means for transferring that competitor's output data to a central data processing means during the course of the sporting event.

13. A method according to claim 12, wherein the means for transferring said output data is a radio transmitter carried by each competitor.

14. A method according to claim 1, wherein each competitor carries a data storage device adapted to store the location data produced for that competitor, so as to allow the data to be collected by a central data processing means after the sporting event.

15. A method according to claim 1, wherein the sporting event is a race, the competitors competing on a racetrack.

16. A method according to claim 15, wherein the sporting event is a horserace.

17. A method according to claim 1, modified by applying the method to a single competitor.

18. Apparatus for monitoring a plurality of competitors in a sporting event, the apparatus comprising:
a. a position locating device to be carried by each of said plurality of competitors;
b. means for causing the position locating devices to make location determinations at intervals and to provide such determinations as output positional location data for the respective competitors; and
c. means for collecting output data for the plurality of competitors.

19. Apparatus according to claim 18, wherein the means for collecting output data comprises a logger unit carried by each competitor which stores the output data.

20. Apparatus according to claim 18, wherein the means for collecting data includes a transmitter carried by each competitor for transmitting said data to a separate data collection and processing unit.

21. Apparatus according to any of claims 18 to 20, wherein the competitor also carries means for converting positional data into speed data representing the speed of the competitor between successive positional location measurements.

22. An apparatus for monitoring a competitor in a sporting event, the apparatus comprising:
a. a position locating device to be carried by the competitor, the device being adapted to make location determinations at intervals and to provide such determinations as output positional location data for the competitor; and
b. means for use in collecting said output data.

23. An apparatus according to claim 22 wherein the means for use in collecting said output data comprises a logger unit for storing data and/or transmitting means for transmitting said data to a separate data collection and processing unit.

24. An apparatus according to claims 22 or 23 wherein the apparatus is for use in a horserace, the apparatus being carried in a horse number cloth.
